(19) United States
(12) Patent Application Publication
(10) Pub. No.: US 2008/0127319 A1
(43) Pub. Date: May 29, 2008

(54) Client based online fraud prevention

(75) Inventors: Michael Galloway, Sunnyvale, CA (US); Bryan Mayes, San Francisco, CA (US); Kaushik E. Lakshmanan, Sunnyvale, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/606,825

(22) Filed: Nov. 29, 2006

(51) Int. Cl. H04L 9/32

(52) U.S. Cl. 726/9

(57) ABSTRACT

An anti-fraud token system is disclosed in which the authentication process is performed primarily on the client side. A client according is provided with an authentication list of websites for which authentication is required, and their respective authentic addresses. The client also asks a user to select a token, which may include graphics, text, and/or sound. When the user accesses an information source from the authentication list, the client notes that the address which the user is accessing is on the list. The client then displays the token as previously selected by the user to the user along with the accessed information, so that the user knows that the information he/she is accessing is authentic.

### BACKGROUND OF THE INVENTION

The popularization of the Internet has lead to several types of illicit behavior. One of these is online fraud. While there are many known types of online fraud, the present disclosure is chiefly concerned with the fraudulent behavior usually referred to as “phishing”. Phishing refers to the practice of presenting information (such as, e.g., a website) to the user which incorrectly purports to originate from a trusted source, and which urges the user to take some action which the user would not usually take had he/she known the true source of the information.

The action the user is urged to take usually involves giving out personal information, and/or passwords, which the fraud perpetrator may later use for illegal purposes. The classic example of phishing is when a hacker creates a webpage or an email message that incorrectly looks like it has been sent out by the user's bank. For example, the user may be presented a webpage which looks exactly like the main login page of the user's bank. The user may then be urged to provide his/her online account name and/or password in order to “login” to his/her account. The fraudulent webpage would then send the account number and password to the fraud perpetrator, who may use this information to access the user's actual bank account and withdraw money therefrom.

There are several known methods for protection from phishing. One is the use of blacklists, i.e., an attempt to identify the internet addresses of phishing perpetrators and to block all communications originating from those addresses. Fraud perpetrators have usually been able to get around this method of protection by quickly changing their Internet addresses and thus staying one step ahead of the security personnel who create and update the various blacklists.

Another known method is used by, among others, BANK OF AMERICA, YAHOO and ING. This method is referred to as SITEKEY (by BANK OF AMERICA) or MEDALLION (by YAHOO). This method is sometimes referred to as reverse authentication to indicate that it requires that a user authenticate a web site instead of the usual case, in which web sites authenticate users. However, to improve clarity, this method will be referred to hereinafter as the server-based anti-fraud token method. According to this method, when the user creates an account with a service, the user is urged to choose a token. The token is usually a small picture. Sometimes, the user is asked to enter a small amount of text as part of the token as well. The token is saved as part of the user's profile. When a user attempts to login to an account, the user is first asked to enter an account name without being asked to enter a password. Once entered, the account name is used to obtain the user's token, and, on a separate page, the user's token is presented along with a field where the user may enter a password. The user is then urged to enter the password only if the user recognizes the previously selected token.

The idea behind the server-based anti-fraud token method is that a fraud perpetrator would not know which token the user chose, and thus would not be able to trick the user into providing a password by showing the correct token.

There are some weaknesses associated with this method. First, the method described above is usually executed separately by each independent entity that wishes to implement it. Therefore, the user must remember one token for accessing a bank, and another token for accessing an investment account, if the investment account is offered by another entity. This may cause confusion for the user, which may greatly impair the security of the system. In other words, if the user is confused as to which token he/she chose, then the security features provided by the token method are rendered ineffective.

The server-based anti-fraud token method also requires that the token be sent to the user through a network (usually the Internet) when the user logs in. This opens another avenue of attack, as a fraud perpetrator may monitor the user's communications and thus determine which token has been chosen.

Another problem with the server-based anti-fraud token method is that its implementation requires that all protected websites revise their authentication software. This is naturally a costly and time consuming prospect for many institutions. Therefore, few institutions have currently adopted this method.

What is needed is a system and a method for providing token based fraud prevention, which may be utilized by multiple websites, and which eliminates or reduces the need of the token to be communicated over the Internet. It would also be very helpful if this method does not require any major software revisions of the authentication systems of protected websites.

### BRIEF SUMMARY OF THE INVENTION

The present invention is directed to an anti-fraud token system in which the authentication process is primarily performed on the client side. A client is provided with a list of websites (or, more broadly, information sources) for which authentication is required, and their respective authentic addresses (the authentication list). The client also asks a user to select a token, which may include graphics, text, and/or sound. In alternate embodiments, the user does not select the token but is otherwise made aware of it. When the user accesses an information source from the authentication list, the client notes that the address being accessed by the user is on the list. The client then displays the token as previously selected by the user along with the accessed information, so that the user knows that the information he/she is accessing is authentic. On the other hand, if the client does not recognize that an address is in the authentication list, no token will be displayed, and the user may then be warned that it is not safe to provide personal data.

Authentication and fraud prevention described herein may be consistent across multiple websites; this minimizes transfers of the token across public networks, and allows the system to be implemented across multiple websites without requiring extensive rewrites of the authentication code of those websites. Furthermore, embodiments of the system may allow the user to select the same token for multiple websites, thus preventing confusion and making the present system easier to use.

Additional embodiments of the invention may further include software for causing a computer to perform a method for authentication and fraud prevention as discussed above, as well as a data signal which may encode data representing such software.

### BRIEF DESCRIPTION OF THE DRAWINGS

FIG. 1 is a diagram of the environment in which exemplary embodiments of the invention operate.

FIG. 2 is a flow chart showing a method of operation of exemplary embodiments of the invention.

FIG. 3 is a diagram showing an example of a token according to embodiments of the invention.

FIG. 4 is a diagram showing the operation of the client authentication software, according to embodiments of the invention.

FIG. 5 is a diagram of a webpage which has been modified according to embodiments of the invention to include an anti-fraud token.

FIG. 6 is a diagram of a webpage including an anti-fraud token according to alternative embodiments of the invention.

FIG. 7 is a diagram of a webpage including an anti-fraud token according to yet other alternative embodiments of the invention.

FIG. 8 illustrates a typical computing system that may be employed to implement processing functionality in embodiments of the invention.

### DETAILED DESCRIPTION OF THE INVENTION

While the present invention is mostly described in connection with webpages, web browsers, web sites, Internet servers and the like, it should be understood that it is not limited to the World Wide Web or the Internet. The present invention may generally refer to any set of information which is considered as a single unit (i.e., an information unit), of which a webpage is a non-limiting example, and which is sent over any type of computer network. Furthermore, while the below description centers on web browsers and web servers, it should be understood that embodiments of the present invention may be used in conjunction with any device or software for presenting an information unit to a user, or for sending the information unit to the user's device over a network.

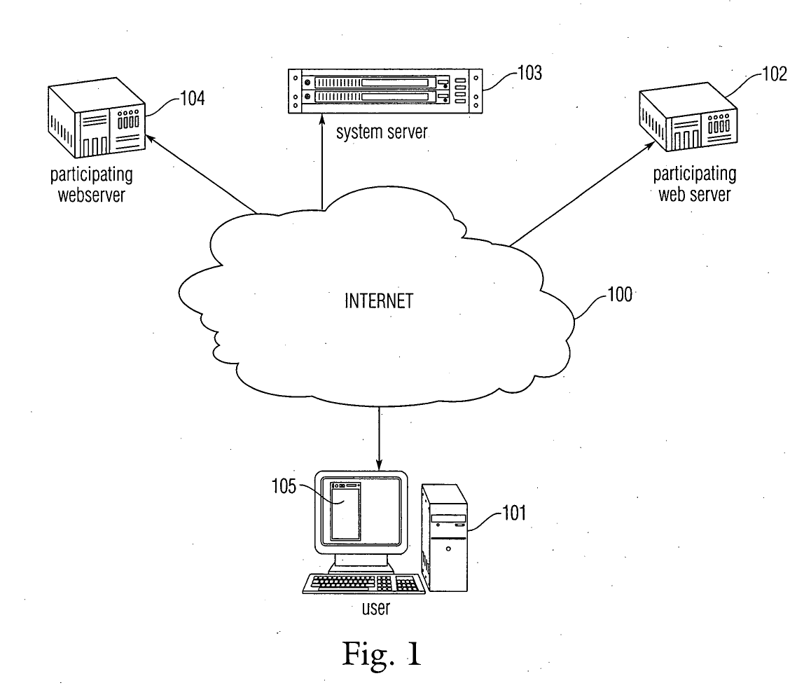

FIG. 1 is a diagram of the environment in which an exemplary embodiment of the invention operates. A user's computer 101 is connected to the Internet 100. Also connected to the Internet are a system server 103, and one or more protected web servers 102, 104. The protected web servers are servers at which websites which are protected by the authentication system described herein are hosted.

The user's computer executes a web browser 105. The user's computer also executes client authentication software (not shown), which may implement aspects of the present invention. The client authentication software may be part of the web browser, a web browser add-on or a distinct application which communicates with the web browser, for example.

The system server is optional. It provides information to the user's computer according to some embodiments of the invention. The system server provides convenience, as information and updates may be quickly sent to the client authentication software. However, the system server may also cause a security weakness, as communications that go over the network can be intercepted by a malicious person. Therefore, some embodiments of the invention do not use a system server, but instead provide the client authentication software with updates and other information through the use of physical media, such as, for example, CDs and DVDs, which the user inserts into computer 101. Other embodiments utilize a system server with encryption of the communications between the client authentication software and the system server in order to minimize any risk of compromise of these communications.

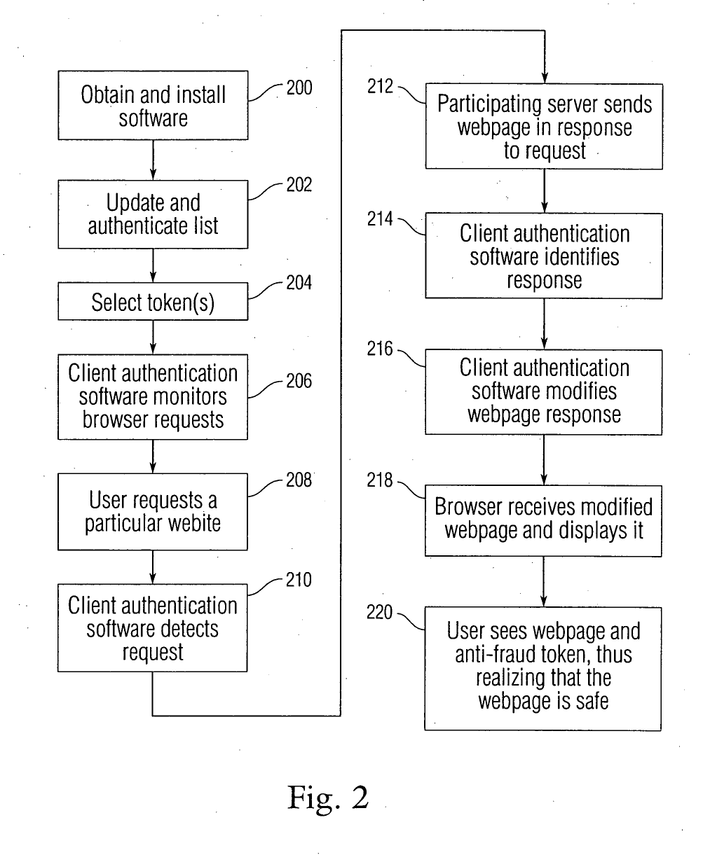

FIG. 2 is a flowchart showing a method of operation of an embodiment of the invention. At step 200, the user obtains and installs the client authentication software on computer 101. The software may be obtained over a network; for example, it may be downloaded from the system server 103 over the Internet 100. In other embodiments, the software may be delivered using traditional storage media such as CDs, DVDs, etc.

The client authentication software may be included in a specifically designed web browser. In an alternative embodiment, the client authentication software may be a distinct application (from the web browser), which serves as a proxy. This embodiment is well suited for cases in which the browser is difficult to modify. In the proxy embodiment, the browser is configured to use the client authentication software as a proxy (and the client authentication software need not necessarily run on the user's computer 101).

In one embodiment, the client authentication software is an addition to a standard browser utilized by the user. Most modern browsers provide for the ability to add additional software to extend their functionality. For example, for the MOZILLA and FIREFOX internet browsers provided by the MOZILLA FOUNDATION, these extensions are referred to as plugins. For the INTERNET EXPLORER browser offered by the MICROSOFT Corporation these extensions are referred to as helper objects. Embodiments of the invention may utilize either or both of these types of extensions for the above mentioned browsers.

At step 202, the authentication list is updated. The authentication list is a list of websites and their respective addresses which are considered to be authentic. In other words, these websites are what they purport to be. Referring to FIG. 1, the authentication list is the list of the protected websites hosted at protected servers 102, 104. In one embodiment, the operators of these websites have consented that their sites be used in combination with the present invention. However, as discussed above, the protected websites need not have their underlying software and structure modified in order to participate in the present system. Thus, in some cases, consent or assistance from the operators of a website are not necessary to protect the website according to certain embodiments of the present invention.

The authentication list may be updated periodically. Therefore, step 202 may be executed at multiple subsequent times. In one embodiment, the updates to the authentication list are downloaded from the system server 103. Alternatively, the updates may be obtained on a storage medium.

The authentication list may include Universal Resource Locators (URLs) and Uniform Resource Identifiers (URIs) of protected websites. The URLs define the global address of each website. The URIs define the location of the login page of each website within that website. The location of the login page is significant for certain embodiments, because in these embodiments certain features of the present system are only activated when a user is looking at a login page. Alternative embodiments may only store the URLs of the protected websites.

In some embodiments only hostnames are stored and each website belonging to a hostname is subject to the security features of the present invention. In other embodiments, regular expressions may be stored, the regular expressions defining one or more hostname, URL, and/or URI pattern.

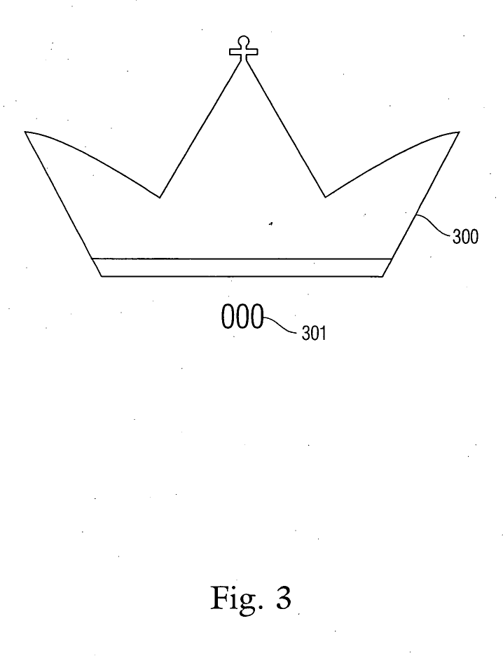

At step 204, the user is requested to select one or more tokens. An example of a token is provided in FIG. 3. Tokens may include graphics, text, sound or any combination of the above. A typical token is a combination of a graphic 300 and text 301. In one embodiment, the user is presented with a plurality of graphics and asked to choose one for his/her token. The user is also requested to add text to the token.

If multiple users complete step 204 at various computers, each user is likely have a unique token. While it is expected that the token will be relatively unique for each respective user, it is not strictly necessary that it be absolutely unique. In other words, in some embodiments there may exist multiple users that have the same token. However, because repetitions will be rare, a malicious party should not be able to easily guess a user's token.

The above type of token is advantageous because it is unlikely to present an undue burden on a user's memory. Simple graphics are easy to remember and the user may choose a text which in his/her mind is associated with the graphic. For example, in FIG. 3 the hypothetical user chose a graphic of a crown, and the text ‘OOO’. The hypothetical user may be a chess player because the crown is a symbol used for the ‘king’ piece in chess, and the text ‘OOO’ denotes a move the king may perform (castle). Another user may choose other text in combination with this graphic, such as for example “King of Barbeque.” Thus, one of the security features of embodiments of the invention is that it would be difficult for an unauthorized party to guess which text a user has chosen to combine with the graphic.

The user may choose a single anti-fraud token, which will be valid for all protected websites. However, some embodiments may allow user to choose multiple tokens and select specific tokens to use for specific websites.

At step 206, the client authentication software monitors requests performed by the browser. Step 206 may be performed continuously after the client authentication software is installed. Therefore, step 206 is placed in its present position in the flow chart to aid the reader's understanding only; it may be performed at any other point in time. The client authentication software examines each request to determine whether it includes a reference to any of the addresses (URIs and optionally URIs) present in the authentication list.

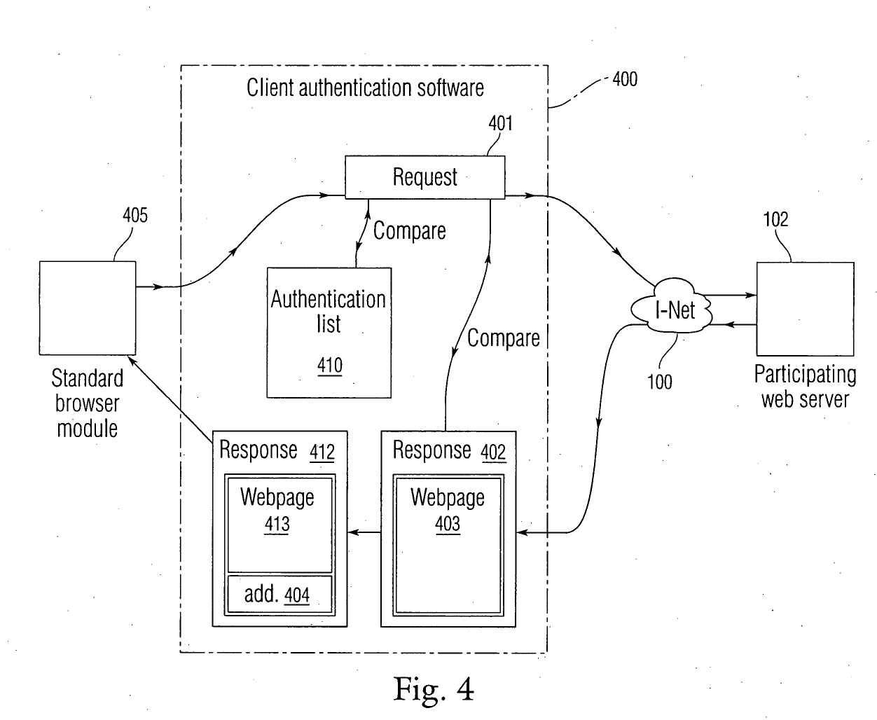

A more detailed schematic of the operation of the client authentication software is shown in FIG. 4. FIG. 4 shows the client authentication software 400 and the standard browser module 405. As discussed above, in some embodiments the client authentication software is part of the browser. Accordingly, the standard browser module is the portion of the browser which is not the client authentication software. Therefore, in some embodiments, the browser 105 is the combination of the standard browser module 405 and the client authentication software 400. In other embodiments, such as the proxy embodiment, the standard browser module 405 is the same as the browser 105 and the client authorization software 400 is a distinct application.

It can be seen in FIG. 4 that as a request 401 is issued by the standard browser module, the client authentication software 400 compares the address of the request, with the addresses stored in the authentication list 410. The other elements of FIG. 4 will be discussed in more detail below.

Turning back to FIG. 2, at step 208, during normal browsing, the user requests a webpage of a protected website. In one embodiment, step 208 happens when the user actually requests an address which specifies an actual user login page of the protected website. In other embodiments, step 208 may be triggered when the user accesses any page of the protected website. When the user requests the webpage, the standard browser module 405 sends an HTTP request to a protected web server 102 (see FIG. 4).

At step 210, the client authentication server detects that the request for the protected website includes an address which is part of the authentication list 410. The client authentication software then saves identifying information for the request (i.e. socket number, HTTP connection number, etc), so that it can identify the response to this request.

At step 212, the protected server sends a response 402 to the request issued by the browser in step 208 (see FIG. 4). The response includes a webpage 403. The client authentication software 400 monitors the data sent to the standard browser module 405 and, at step 214, identifies when a response to the request it previously identified is received. Thus, the response is matched to the previously identified request by socket, number, HTTP connection number, address, etc.

At step 216, the client authentication software modifies the webpage 403 (see FIG. 4) within the response in order to add the anti-fraud token. Therefore, the client authentication software converts response 402 into response 412, which is similar to response 402 but includes some additions 404 to the webpage 403 (which together form modified webpage 413).

The additions may be made using Dynamic HTML (DHTML). Dynamic HTML is a known format for providing dynamic content in webpages. The DHTML format allows for various layers within a webpage. An HTML document may comprise a single DHTML layer. Therefore, if the webpage 403 is originally in HTML the preferred embodiment converts it into a DHTML document 413 by keeping the original content as a first DHTML layer and adding a second DHTML layer which defines the anti-fraud token. If the original webpage 403 is a DHTML page, the client authentication software 400 modifies it by adding an additional DHTML layer which defines the anti-fraud token. If multiple anti-fraud tokens are being used, the client authentication software checks which protected website the webpage originated from (by examining the response 402, or the request 401 for an address), and selects the respective anti-fraud token to add to the webpage 403.

While, to improve clarity, the response 402 and modified response 412 are shown in FIG. 4 as blocks, it should be understood that the response may be treated as a stream. In other words, the client authentication software may modify parts of the response (or webpage 403) while other parts are still being received from the protected server, or while other parts are actually being received and rendered on the screen by the standard browser module 405.

In an alternative embodiment, the client authentication software does not check requests for addresses from the authentication list 410 and attempt to match them to their respective responses. It simply checks the responses for those addresses and adds an anti-fraud token to each response which includes an address indicating it came from a protected website. This embodiment is simpler and faster, but may not be as effective because responses with fraudulent addresses may be created by using a technique referred to as ‘spoofing’.

Turning back to FIG. 2, at step 218, the standard browser module 405 receives the modified webpage and displays it with the added anti-fraud token. If the anti-fraud token is a sound, the browser plays it instead. At step 220, the user sees the webpage and the anti-fraud token. Having noticed the anti-fraud token, the user realizes that he/she may safely interact with the webpage (by, for example, entering sensitive information in various fields). If on the other hand, the user sees a website that asks for sensitive information but does not include an anti-fraud token, the user knows that this website has not been shown to be safe by the present system and utilizes additional caution.

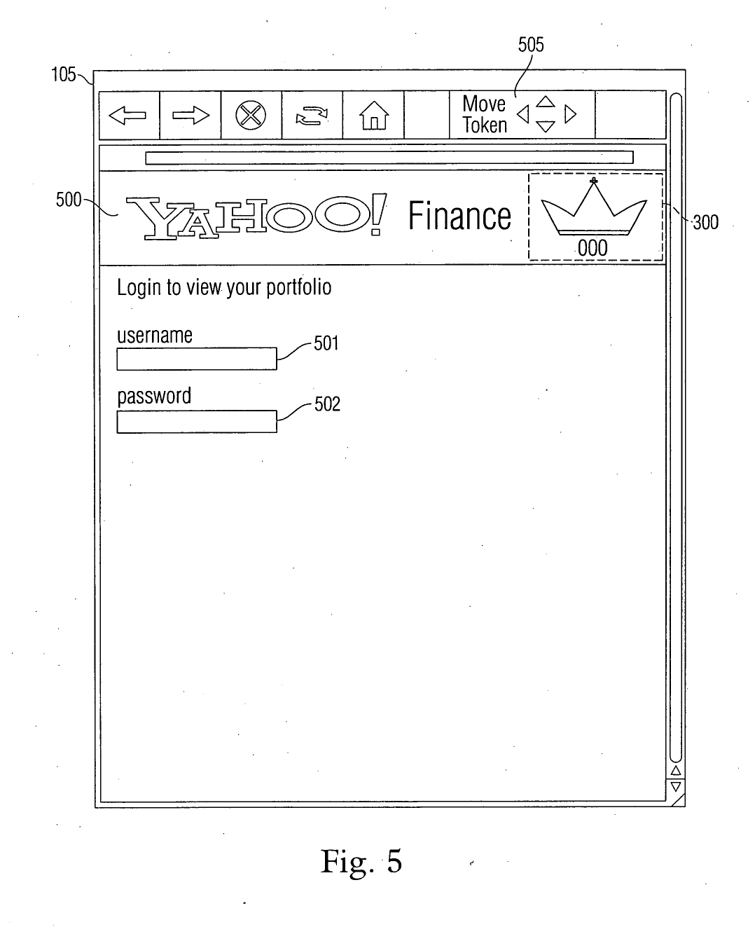

FIG. 5 is an example of a webpage 500 (as displayed by browser 105) with an anti-fraud token 300 embedded therein. Having seen the anti-fraud token, the user may confidently enter his/her username and password.

Embodiments of the invention allow a user to move the anti-fraud token around the webpage. Thus a user may move the anti-fraud token away from useful portions of the webpage (such as, for example, username and password fields 501, 502).

The ability to move the anti-fraud token may be provided by using known DHTML commands that allow an object to be moveable by a user. Thus, a user will be able to move the anti-fraud token 300 by clicking on it with a mouse and “dragging” it around the webpage 500.

In one embodiment of the invention, the system actually remembers the movements of the anti-fraud token. Thus, if the user moves the antifraud token 300 to the upper right hand corner of the webpage 500 (as shown), the token will appear at that location the next time the user accesses this particular webpage.

This feature provides two benefits. The first is convenience. If a user has to move the token out of the way, it would be much more convenient if the token moving step could be performed only once for each protected website. The second benefit is additional security. If the user knows that the system remembers where the token was placed the last time a particular site was visited, then if the token appears at another place next time the user visits the site, the user will know that something is amiss. Thus, even if a potential fraud perpetrator somehow correctly guesses a user's token, he/she may not be able to fool the user without also guessing where in the webpage the user left the token last.

In order to perform the above described token location memory feature, the client authentication software must be informed as to where the user moves the token. Therefore, if standard DHTML features are used to allow movement of the token, an applet (preferably in JavaScript) may be placed in the same DHTML layer as the token. That applet may track the current position of the token and send information as to its position to the client authentication software. The client authentication software would in turn save the last position for the token for each protected webpage and re-insert the token in that position when the protected webpage is viewed for a second time.

In an alternative embodiment, the user is not allowed to move the token by simply clicking on it and dragging it. Instead, the user is provided with a visual toolbox 505 located at the browser's interface 105. The toolbox is created by the client authentication software. The user may move the anti-fraud token by clicking on the various arrows of the toolbox. Thus, the client authentication software receives the user's movement commands directly and in turn causes the token 300 to move. The client authentication software may cause the token to move by creating newer versions of the webpage 500 and causing the browser to refresh to these newer versions.

In an alternative embodiment the movement (or alternatively, only the last position) of the anti-fraud token is sent to the system server 103 and saved thereon. The system server 103 then sends the various positions of the anti-fraud tokens for the various protected websites to the client authentication server 400 periodically with the updates of the authentication list. This embodiment is may be implemented in portable versions of the present invention which are designed to allow the user to easily utilize the present invention from different computers.

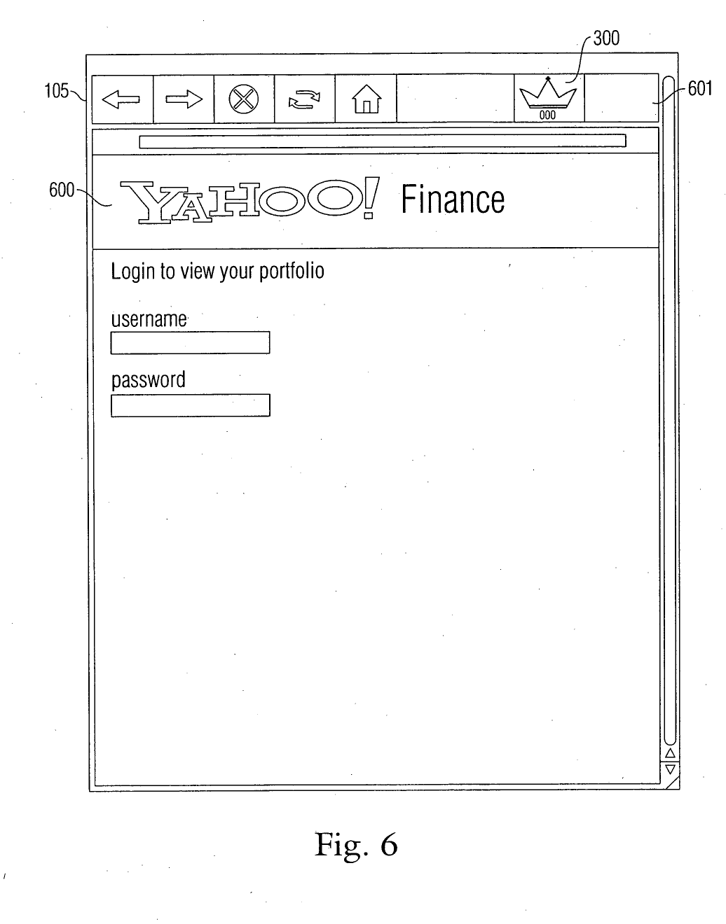

FIG. 6 is a diagram of a webpage 600 including an anti-fraud token according to alternative embodiments of the invention. Specifically, while in the previous embodiments the anti-fraud token was inserted in the body of the webpage, in this embodiment it is inserted in the browser's interface 601. Thus, the client authentication software does not modify the webpage at all, but having determined that the webpage is from a protected website, it modifies the browser's interface to place a client request token.

In theory, the embodiment of FIG. 6 may be more secure as it is much more difficult for a potential fraud perpetrator to modify the browser's interface than to modify a webpage. However, in practice the embodiments which place the token in the webpage may be more desirable, because users often do not notice elements on the browser's interface and only pay attention to the content of webpages. If the user does not notice the anti-fraud token, its usefulness is very limited.

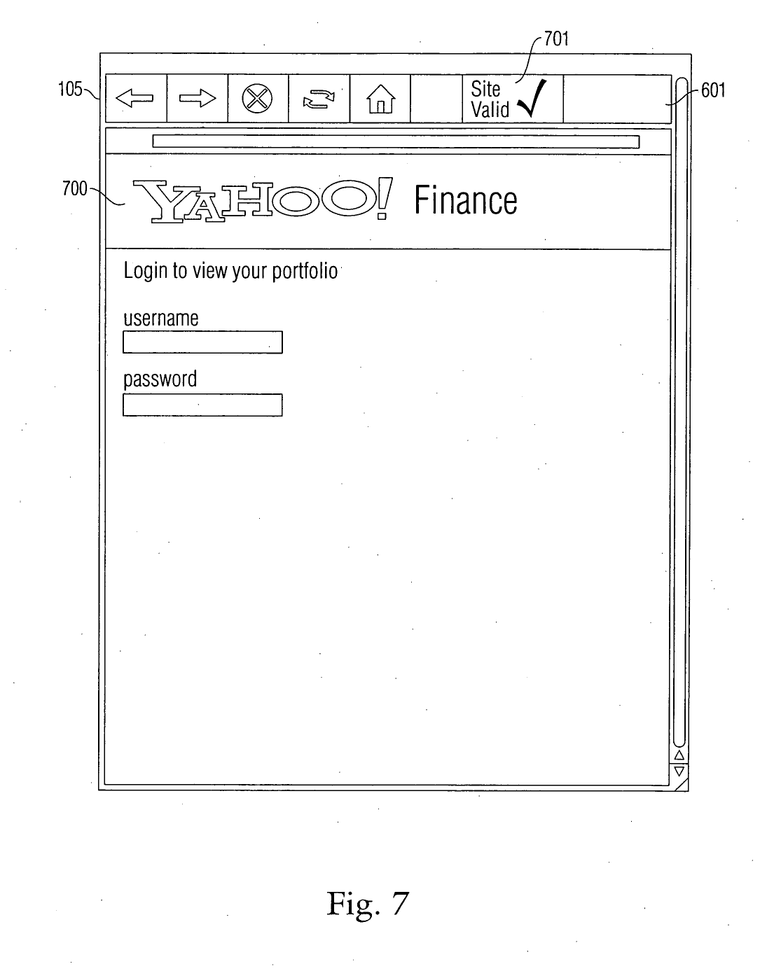

Since the illicit modifying of a browser's interface is considered to be difficult, embodiments which place the anti-fraud token on the browser's interface may do away with the custom token selection procedure. An example of such an embodiment is shown in FIG. 7 (showing website 700). This embodiment may not request that a user select and remember a custom token but may instead use a generic token, such as site valid sign 701. In this embodiment, sign 701 would be the same for all protected websites and users.

While the invention has been described in terms of particular embodiments and illustrative figures, those of ordinary skill in the art will recognize that the invention is not limited to the embodiments or figures described. Although embodiments of the present invention are described, in some instances, using HTTP, HTML and DHTML terminology, those skilled in the art will recognize that such terms are also used in a generic sense herein, and that the present invention is not limited to such systems.

Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

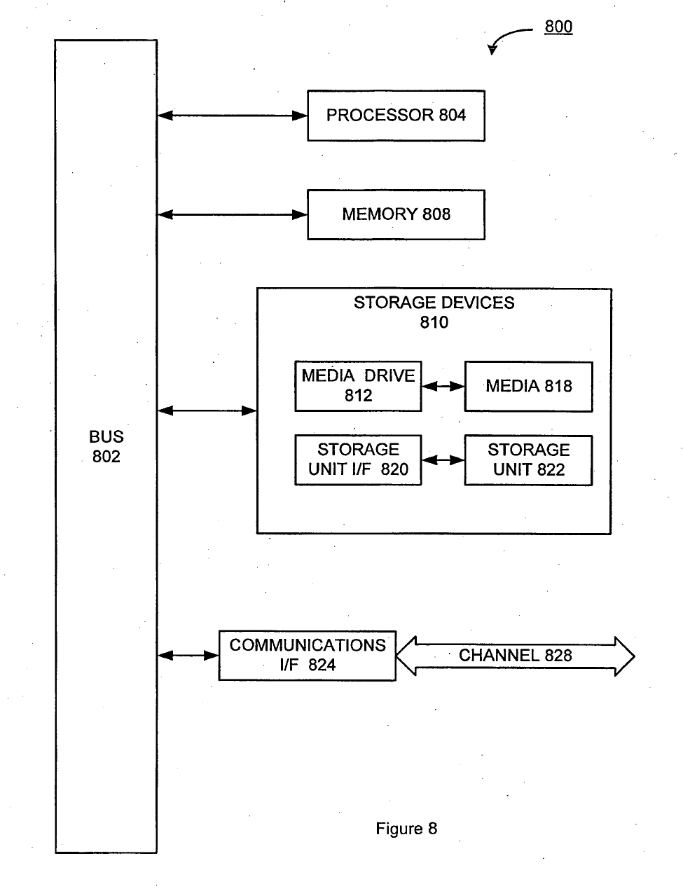

FIG. 8 illustrates a typical computing system 800 that may be employed to implement processing functionality in embodiments of the invention. Computing systems of this type may be used in the system server, the user terminal, and the protected web servers, for example. Those skilled in the relevant art will also recognize how to implement the invention using other computer systems or architectures. Computing system 800 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 800 can include one or more processors, such as a processor 804. Processor 804 can be implemented using a general or special purpose processing engine such as, for example, a microprocessor, microcontroller or other control logic. In this example, processor 804 is connected to a bus 802 or other communications medium.

Computing system 800 can also include a main memory 808, such as random access memory (RAM) or other dynamic memory, for storing information and instructions to be executed by processor 804. Main memory 808 also may be used for storing temporary variables or other intermediate information during execution of instructions to be executed by processor 804. Computing system 800 may likewise include a read only memory (“ROM”) or other static storage device coupled to bus 802 for storing static information and instructions for processor 804.

The computing system 800 may also include information storage system 810, which may include, for example, a media drive 812 and a removable storage interface 820. The media drive 812 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 818, may include, for example, a hard disk, floppy disk, magnetic tape, optical disk, CD or DVD, or other fixed or removable medium that is read by and written to by media drive 814. As these examples illustrate, the storage media 818 may include a computer-readable storage medium having stored therein particular computer software or data.

In alternative embodiments, information storage system 810 may include other similar components for allowing computer programs or other instructions or data to be loaded into computing system 800. Such components may include, for example, a removable storage unit 822 and an interface 820, such as a program cartridge and cartridge interface, a removable memory (for example, a flash memory or other removable memory module) and memory slot, and other removable storage units 822 and interfaces 820 that allow software and data to be transferred from the removable storage unit 818 to computing system 800.

Computing system 800 can also include a communications interface 824. Communications interface 824 can be used to allow software and data to be transferred between computing system 800 and external devices. Examples of communications interface 824 can include a modem, a network interface (such as an Ethernet or other NIC card), a communications port (such as for example, a USB port), a PCMCIA slot and card, etc. Software and data transferred via communications interface 824 are in the form of signals which can be electronic, electromagnetic, optical or other signals capable of being received by communications interface 824. These signals are provided to communications interface 824 via a channel 828. This channel 828 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 808, storage device 818, or storage unit 822. These and other forms of computer-readable media may store one or more instructions for use by processor 804, to cause the processor to perform specified operations. Such instructions, generally referred to as “computer program code” (which may be grouped in the form of computer programs or other groupings), when executed, enable the computing system 800 to perform functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 800 using, for example, removable storage drive 814, drive 812 or communications interface 824. The control logic (in this example, software instructions or computer program code), when executed by the processor 804, causes the processor 804 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A system for allowing a user to view an information unit obtained from an information source over a network while preventing misrepresentations in the information unit, the system comprising:
a memory including
a token associated with the user and known by the user, and
a list including a plurality of addresses, each address associated with a trusted information unit; and
a client module operable to retrieve information units from the network and present them to the user, and if a trusted information unit is to be retrieved from one of the addresses included in the list, to cause the token to be presented to the user when the trusted information unit is being presented to the user,
wherein presentation of the token to the user informs the user that the information unit presented to the user is trusted.

2. The system of claim 1, the client module comprising:
an information presentation module operable to retrieve information units from the network and present them to the user; and
a client authentication module operable to detect when the information presentation module retrieves a trusted information unit whose address is included in the list and to cause the information presentation module to present the token to the user when the trusted information unit is being presented.

3. The system of claim 1, wherein the client module further comprises a token definition module which allows the user to define the token.

4. The system of claim 1, wherein the token includes text.

5. The system of claim 1, wherein the token includes a graphic.

6. The system of claim 5, wherein the token includes text.

7. The system of claim 1, wherein the token includes a sound.

8. The system of claim 2, wherein the information units are webpages, the trusted information unit is a trusted webpage, the network is the Internet and the information presentation module is a web-browser.

9. The system of claim 8, wherein the addresses comprise a URL.

10. The system of claim 9, wherein at least one of the webpages is a login webpage and the addresses further comprise a Uniform Resource Identifier (URI) of the login webpage.

11. The system of claim 8, wherein the client authentication module is an extension of the web browser.

12. The system of claim 8, wherein the client authentication module is a proxy, and the web browser is operative to communicate through the proxy.

13. The system of claim 8, wherein the client authentication software is operative to insert the token into the trusted webpage before the trusted webpage is rendered by the browser.

14. The system of claim 13, wherein the client authentication module is operative to monitor communications of the web browser, detect a communication which includes a request addressed to one of the addresses included in the list, detect a response to the request, obtain the trusted webpage from the response, and modify the trusted webpage to include the token.

15. The system of claim 13, wherein the token is displayed to the user as an image superimposed on the trusted webpage.

16. The system of claim 15, wherein the token is operative to allow the user to move the token around the trusted webpage.

17. The system of claim 16, wherein the client authentication module is operative to save the position of the token in response to movements of the token by the user, and in the event that the user accesses the trusted webpage at a later time, to display the token at its last saved position on the trusted webpage.

18. The system of claim 17, wherein the token is added to the trusted webpage by creating an additional DHTML layer within the trusted webpage, said additional DHTML layer including code defining the token.

19. The system of claim 18, wherein the code defining the token includes code allowing the user to move the token and code which communicates to the client authentication module any movements of the token.

20. The system of claim 17, wherein the client authentication module is further operative to modify the interface of the web browser to add a visual toolbox to said interface, the visual toolbox allowing the user to move the token.

21. A method for allowing a user to view an information unit obtained from an information source over a network while preventing misrepresentations in the information unit, the method comprising:
defining a token that is known to the user;
receiving an information unit having an address associated with it;
determining whether the address of the information unit is included in a list including a plurality of addresses, each address associated with a trusted information unit; and
if the address of the information unit is included in the list, causing the token to be presented to the user when the information unit is being presented to the user;
wherein the token signifies to the user that the information unit is trusted.

22. The method of claim 21, further including:
periodically updating the list by accessing a system server located remotely from the user on the network.

23. The method of claim 21, further comprising allowing the client to define the token.

24. The method of claim 21, wherein the token includes at least one element chosen from the group consisting of: a graphic, text, a sound, a combination of graphic and text.

25. The method of claim 21, wherein the various information units are webpages, and the network is the Internet.

26. The method of claim 25, wherein the address comprises a URL.

27. The method of claim 26, wherein at least one of the webpages is a login webpage and the address further comprises a URI of the login webpage.

28. The method of claim 25, wherein causing the token to be presented to the user comprises inserting the token into the webpage which represents the information unit.

29. The method of claim 28:
wherein determining comprises
monitoring the communications of a web browser,
detecting a communication which includes a request addressed to one of the addresses included in the list, and
detecting a response to the request;
and wherein inserting the token into the webpage further comprises
obtaining a webpage from the response, and
modifying the webpage to include the token.

30. The method of claim 28, wherein causing the token to be presented to the user further comprises causing the token to be displayed to the user as an image superimposed on the webpage.

31. The method of claim 30, further comprising allowing the user to move the token around the webpage.

32. The method of claim 31, further comprising:
saving the position of the token in response to movements of the token by the user; and
in the event that the user accesses the webpage at a later time, displaying the token at its last saved position on the webpage.

33. The method of claim 32, wherein inserting the token into the webpage further comprises:
creating an additional DHTML layer within the trusted webpage; and
placing code defining the token in the additional DHTML layer.

34. The method of claim 33, wherein:
allowing the user to move the token is performed by the code defining the token; and
saving the position of the token is performed by a client authentication module, the method further including communicating any movements of the token to a client authentication module by the code defining the token.

35. The method of claim 32, further comprising:
modifying the interface of the web browser to add a visual toolbox to said interface; and
allowing the user to move the token by interacting with the visual toolbox.

36. A computer readable medium comprising program code for allowing a user to view an information unit obtained from an information source over a network while preventing misrepresentations in the information unit, the program code for causing performance of a method comprising:
defining a token which is known to the user;
receiving an information unit having an address associated with it;
determining whether the address of the information unit is included in a list including a plurality of addresses, each address associated with a trusted information unit; and
if the address of the information unit is included in the list, causing the token to be presented to the user when the information unit is being presented to the user;
wherein the token signifies to the user that the information unit is trusted.

37. The computer readable medium of claim 36, wherein the method further includes:
periodically updating the list by accessing a system server located remotely from the user on the network.

38. The computer readable medium of claim 37, wherein the method further comprises allowing the client to define the token.

39. The computer readable medium of claim 36, wherein the token includes one or more elements chosen from the group consisting of: a graphic, text and a sound.

40. The computer readable medium of claim 36, wherein the various information units are webpages, and the network is the Internet.

41. The computer readable medium of claim 40, wherein the address comprises an URL.

42. The computer readable medium of claim 41, wherein at least one of the webpages is a login webpage and the address further comprises a URI of the login webpage.

43. The computer readable medium of claim 40, wherein causing the token to be presented to the user comprises inserting the token into the webpage which represents the information unit.

44. The computer readable medium of claim 43:
wherein determining comprises
monitoring the communications of a web browser,
detecting a communication which includes a request addressed to one of the addresses included in the list, and
detecting a response to the request;
and wherein inserting the token into the webpage further comprises
obtaining a webpage from the response, and
modifying the webpage to include the token.

45. The computer readable media of claim 43, wherein causing the token to be presented to the user further comprises displaying the token to the user as an image superimposed on the webpage.

46. The computer readable medium of claim 45, wherein the method further comprises allowing the user to move the token around the webpage.

47. The computer readable medium of claim 46, wherein the method further comprises:
saving the position of the token in response to movements of the token by the user; and
in the event that the user accesses the webpage at a later time, displaying the token at its last saved position on the webpage.

48. The computer readable medium of claim 47, wherein inserting the token into the webpage further comprises:
creating an additional DHTML layer within the trusted webpage; and
placing code defining the token in the additional DHTML layer.

49. The computer readable medium of claim 48, wherein:
allowing the user to move the token is performed by the code defining the token; and
saving the position of the token is performed by a client authentication module, the method further including communicating any movements of the token to a client authentication module by the code defining the token.

50. The computer readable medium of claim 47, wherein the method further comprises:
modifying the interface of the web browser to add a visual toolbox to said interface; and
allowing the user to move the token by interacting with the visual toolbox.

51. A server system for allowing a user to view an information unit obtained from an information source over a network while preventing misrepresentations in the information unit, comprising:
a computer readable medium comprising program code for causing performance of a method comprising:
defining a token which is known to the user,
detecting a received information unit, the information unit having an address associated with it,
determining whether the address of the information unit is included in a list including a plurality of addresses, each address associated with a trusted information unit, and
if the address of the information unit is included in the list, causing the token to be presented to the user when the information unit is being presented to the user, wherein the token signifies to the user that the information unit is trusted;
a communications interface operative to connect to a network;
a processor for obtaining the program code from the computer readable medium and for sending the program code through the communications interface and the network to a user's computer.

52. The server system of claim 51, further comprising a second computer readable medium which includes the list, wherein the microprocessor is further operative to obtain the list from the second computer readable medium and to send the list send the list through the communications interface and the network to a user's computer.

53. The server system of claim 51, wherein the method further comprises allowing the client to define the token.

54. The server system of claim 51, wherein the token includes one or more elements chosen from the group consisting of: a graphic, text and a sound.

55. The server system of claim 51, wherein the various information units are webpages, the network is the Internet, and causing the token to be presented to the user comprises inserting the token into the webpage which represents the information unit.

56. The server system of claim 55:
wherein determining comprises
monitoring the communications of a web browser,
detecting a communication which includes a request addressed to one of the addresses included in the list, and
detecting a response to the request;
and wherein inserting the token into the webpage further comprises
obtaining a webpage from the response, and
modifying the webpage to include the token.

57. The server system of claim 55, wherein causing the token to be presented to the user further comprises displaying the token to the user as an image superimposed on the webpage.

58. The server system of claim 57, wherein the method further comprises allowing the user to move the token around the webpage.

59. The server system of claim 58, wherein the method further comprises:
saving the position of the token in response to movements of the token by the user; and
in the event that the user accesses the webpage at a later time, displaying the token at its last saved position on the webpage.

60. The server system of claim 59, wherein inserting the token into the webpage further comprises:
creating an additional DHTML layer within the trusted webpage; and
placing code defining the token in the additional DHTML layer.

61. The server system of claim 51, further comprising a storage area network connectable to the communication interface and a plurality of storage devices connected to the storage area network.

62. The server system of claim 51, further comprising a plurality of server computers, interconnected through the network, wherein each server computer has access to the program code comprised by the computer readable medium.

63. A modulated data signal comprising encoded data, the encoded data comprising program code for allowing a user to view an information unit obtained from an information source over a network while preventing misrepresentations in the information unit, the program code for causing performance of a method comprising:
storing a list including a plurality of addresses, each address associated with a trusted information unit;
defining a token which is known to the user;
receiving an information unit having an address associated with it;
determining whether the address of the information unit is included in the list; and
having determined that the address of the information unit is included in the list, causing the token to be presented to the user at a time when the information unit is being presented to the user;
wherein the token signifies to the user that the information unit is trusted.
